(19) United States
(12) Patent Application Publication
(10) Pub. No.: US 2007/0177403 A1
(43) Pub. Date: Aug. 2, 2007

(54) Prism of backlight module and structure thereof

(75) Inventors: Chih-Chun Hsiao, Padeh City (TW); Cheng-Min Liao, Padeh City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Chunghwa Picture Tubes, Ltd., Padeh City (TW)

(21) Appl. No.: 11/343,315

(22) Filed: Jan. 31, 2006

(51) Int. Cl. F21V 7/04

(52) U.S. Cl. 362/600

(57) ABSTRACT

A prism of backlight module and structure thereof is provided. The prism includes a central area on which geometrical units are formed and arranged adjacent to each other on the prism and a periphery area, being a planar structure, located at two sides outside the central area and terminated at edges of the prism. The prism applied to a backlight module is provided by an integrity process or mold punching process or by providing a shielding surface formed by an ink print method on a lower surface of a base of the periphery area of the prism. As such, the problem of light condensing at edges of the prism in a general notebook computer due to absence of an upper diffuser may be reduced and light leakage may also be reduced.

### BACKGROUND OF THE INVENTION

1. Field of the Invention

The present invention relates to a prism and particularly to a prism of the backlight module, which can reduce light condensing at edges of a prism and the light leaking problem

2. Descriptions of the Related Art

Today, there is more and more critical demand of compactness and cost saving placed on a notebook computer. To meet with these requirements, an upper diffuser is generally not provided on a backlight module of a display of the notebook computer so that thickness of the backlight module may be reduced.

The backlight module of the display in the notebook computer may be seen in FIG. 1. The backlight module comprises, from bottom to top, a reflective mask 10, a lamp unit 11, a mold frame 12, a reflector 13, a light guide plate 14, a diffuser 15, and a prism 16. The diffuser 15 has an adverse impact to beam pointing characteristics and thus reduces use efficiency of the light from the backlight module since the notebook computer is generally displayed for a user only from the front. To resolve this problem, a prism capable of light condensing is generally introduced over the diffuser 15 so as to change the direction of the backlight, which may be schematically illustrated by FIG. 2. With the provision of the additional prism, the backlight is guided from the reflector 13 through the light guide plate 14, the diffuser 15, to the prism 16. By means of the reflection and refraction, the purpose of light condensing and front luminance promoting may be achieved. As such, use efficiency of the light from the diffuser and thus the overall luminance provided by the backlight module may be increased.

The prism 16 is generally made of polyester or polycarbonate and has a diamond columned or semi-columned surface structure. More specifically, the prism 16 is a thin sheet of approximate 150 to 230 μm, on which a cone-shaped prism array is formed with the neighboring cones therein having a distance of 24 to 110 μm and a top angle of 90 to 110 degrees. As such topologically devises, the prism 16 features good light condensing. However, the absence of the upper diffuser may bring to light condensing at edges of the prisms and further to light leakage. In view of this problem, some printing patterns are provided on the lower diffuser (so as to mask some light leakage) and black tapes for light masking are bonded onto a glass of the LCD at peripheral regions of a rear side, which is taken as the primary measure toward the light condensing and leakage issue. Some of the black tapes are bonded onto terminals while the other onto the gate side and an opposite side of the gate of the LCD panel with respect thereto so as to mask the light from the terminals of LCD panel and thus prevent light leakage mentioned above. As shown in FIG. 3, the black tapes are bonded onto a bonding position 20. Although the black tapes are used and the printing patterns are provided on the lower diffuser, a very minor portion of the backlight is transmitted into an A area and thus the mentioned light leakage arises. Further, since gaps may be avoidably formed when the black tapes are bonded and a proper bonding may not be totally achieved through a manual manner, the mentioned light leakage is hard to be prevented.

In light of the above shortcomings, the present invention provides a prism backlight and structure thereof having a reduced light condensing at two sides thereof through which light leakage may be reduced, bright lines may be prevented and thus use efficient of the backlight may be increased. As such, the final optical effect of the prism may be superior.

### SUMMARY OF THE INVENTION

It is, therefore, an object of the present invention to provide a prism applied to a backlight module having a reduced light condensing at two sides thereof through which light leakage may be reduced, bright lines may be prevented and thus use efficiency of the backlight may be promoted.

To achieve the above object, the present invention discloses a prism of backlight module and structure thereof comprising a central area wherein the central area on which geometrical units are formed and arranged adjacent to each other on the prism and a periphery area, wherein the periphery area being a plane, located at two sides outside the central area and terminated at edges of the prism.

To achieve the above object, the present invention discloses a prism of backlight module and structure thereof. The prism comprises a central area on which first geometrical units are formed and arranged adjacent to each other on the prism and a periphery area wherein the periphery area is the area where second geometrical units are formed on two sides outside the central area and terminated at edges of the prism. Within the periphery area, a shielding surface is formed by an ink print method on a lower surface of a base of the periphery area.

To achieve the above object, the present invention discloses a prism of backlight and structure thereof comprising a central area on which geometrical units are formed and arranged adjacent to each other on the prism and a periphery area, being a plane, located at two sides outside the central area and terminated at edges of the prism. Within the periphery area, a shielding surface is formed by an ink print method on a lower surface of a base of the periphery area.

Another object of the present invention to provide a backlight module having a reduced light condensing at two sides thereof through which light leakage may be reduced, bright lines may be prevented and thus use efficiency of the backlight may be promoted.

To achieve the above object, in the present invention, the plane is provided on two sides of the prism by an integrity process or mold punching process in the prism of the backlight module. Alternatively, ink may be additionally provided on the lower surface of the base of the prism. As such, because of applying the prism to the backlight module, light leakage occurred at terminals of LCD panel or adjacent to gates and light condensing occurred at edges of the prism may be reduced and use efficiency of the backlight may be promoted.

To enable the objects, structural features and efficacies of the present invention to be apparent to persons skilled in the art, the present invention will be described taken from the preferred embodiments in more detail with reference to the accompanying drawings.

### BRIEF DESCRIPTION OF THE DRAWINGS

FIG. 1 is a schematic diagram of a backlight structure of a conventional notebook computer;

FIG. 2 is a schematic diagram of a proceeding direction of a light emitted from a side-edge backlight structure of a conventional notebook computer;

FIG. 3 is a cross sectional view illustrating a bonding position of a black tape for light masking of a side-edge backlight structure of the conventional notebook computer;

FIG. 4A and FIG. 4B show a schematic diagram of a prism according to the first embodiment of the present invention;

FIG. 5 shows a schematic diagram of a prism according to the second embodiment of the present invention; and

FIG. 6 shows a schematic diagram of a prism according to the third embodiment of the present invention.

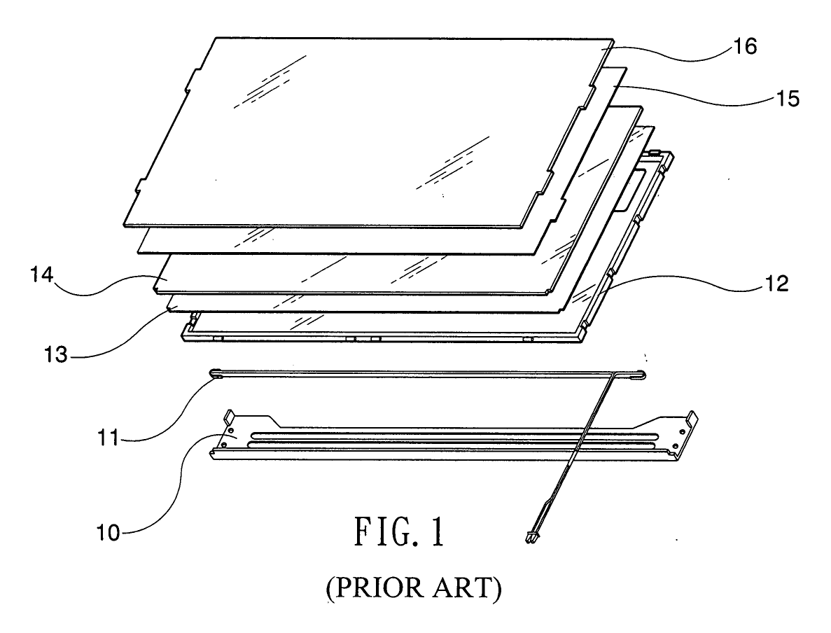

### DETAILED DESCRIPTION OF THE INVENTION

The present invention discloses a prism of backlight module and structure thereof, which will be explained through the preferred embodiments below.

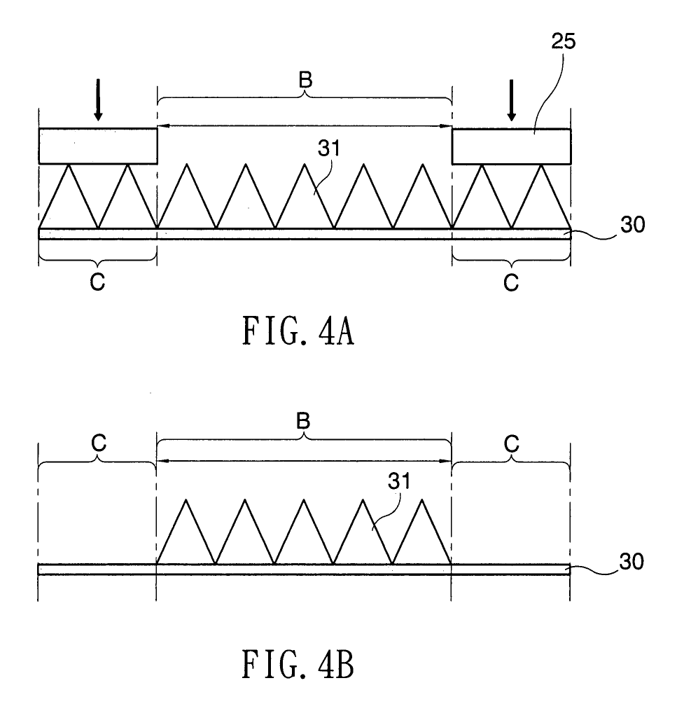

Referring to FIG. 4A and FIG. 4B, a diagram of a prism according to a first embodiment of the present invention is shown therein. As shown, the prism 30 comprises a central area B and a periphery area C. Within the central area B, several geometrical units 31 are formed and arranged adjacent to each other on the prism 30 as a whole. The periphery area C is a planar structure, formed by an integrity process or punching process through a mold 25. In prior art, when a light passes the periphery area C, light condensing is brought about at sides of the prism 30 due to structure thereof. However, in the embodiment of the present invention, since the structure at sides of the prism 30 is flattened by punching through a mold 25 (shown in FIG. 4A) or formed integrally (shown in FIG. 4B), light condensing may be reduced at flattened sides of the prism and bright lines may be prevented. As related to the several geometrical units 31, each has an angle a ranging from 90 to 110 degrees, a height of approximate 30 μm and a distance of approximate 50 μm.

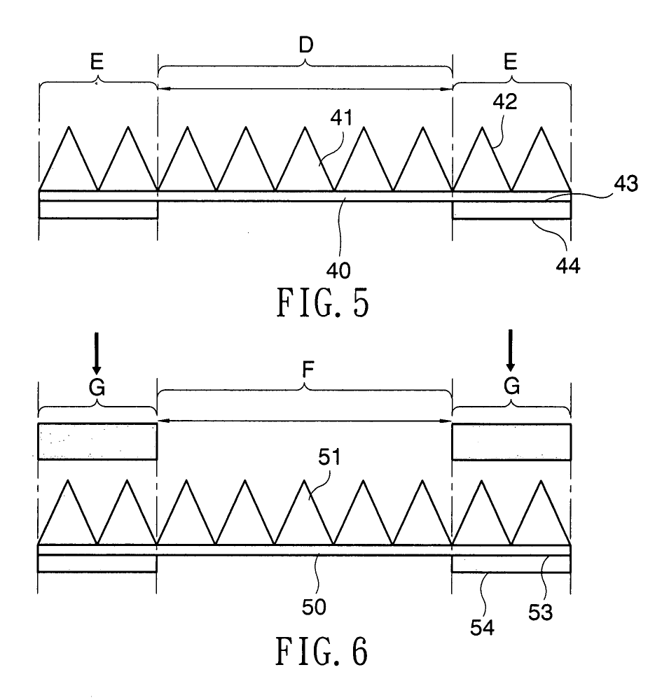

Referring to FIG. 5, a prism 40 according to a second embodiment of the present invention is shown therein. The prism comprises a central area D and a periphery area E. The periphery area E has a lower surface 43. Within the central area D, several first geometrical units 41 are formed and arranged adjacent to each other on the prism 40. The periphery area E is located at two sides of the display area D and terminated at edges of the prism 40. The periphery area E has several second geometrical units 42 formed thereon, which are located at the same side as the first geometrical units 41 and arranged adjacent to each other on the prism 40. In addition, the first geometrical units 41 and the second geometrical units are integrated. This embodiment is identical to the first embodiment in structure and material, except for a shielding surface 44 formed on the lower surface 43 of a base of the prism within the periphery area E by an ink print method. By means of the shielding surface 44, light condensing occurred at edges of the prism 40 is reduced and light leakage is prevented.

Referring to FIG. 6, a schematic diagram of a prism 50 according to a third embodiment of the present invention is shown therein. As shown, the prism 50 comprises a central area F and a periphery area G. Within the central area F, several geometrical units 51 is formed and arranged adjacent to each other on the prism 50. The periphery area G, being a planar prism structure, is located at two sides outside the central area F and terminated at edges of the prism 50. This embodiment is achieved through a combination of the first and second embodiments and identical to the first embodiment in structure and material, except that a shielding surface 54 formed on the lower surface 53 of a base of the planar prism structure of the periphery area G by the ink print method in the second embodiment is also provided in the third embodiment so as to achieve the purpose of reduction of light condensing and light leakage occurred at edges of the prism.

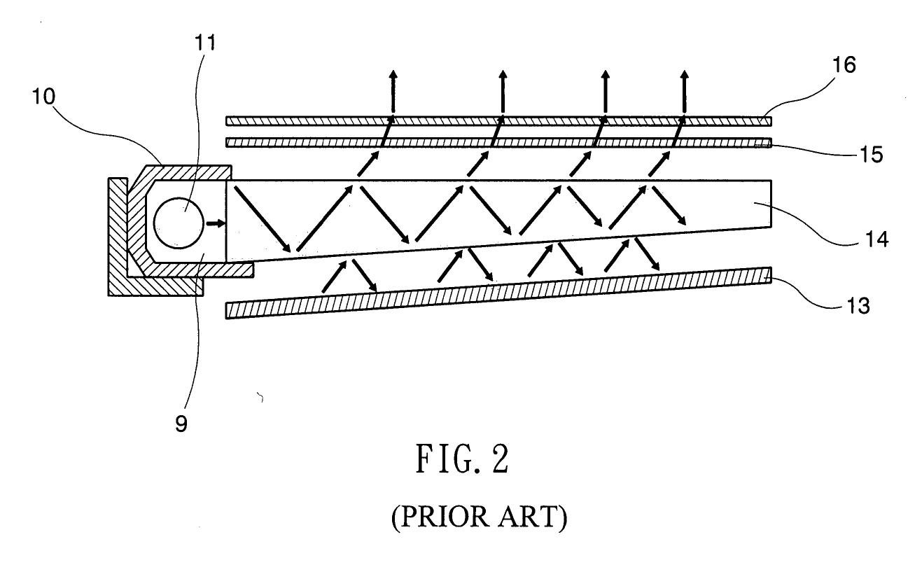

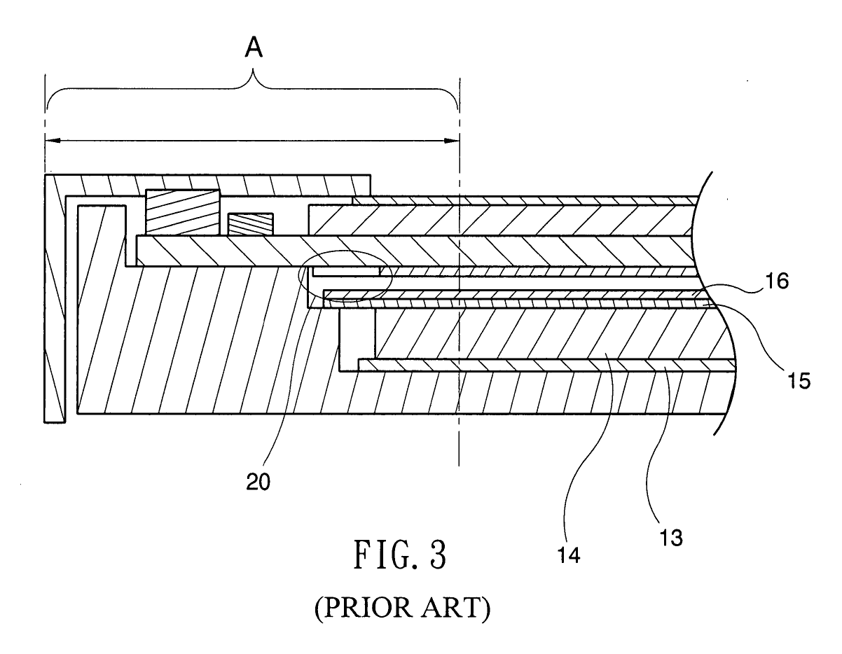

The prism mentioned on the above embodiments can be applied to a backlight module. As shown in FIG. 2, the backlight module comprises a reflective mask 10 having a chamber 9, a lamp unit 11 disposed on the chamber 9, a light guide plate 14 disposed on one side of the lamp unit 11, a reflector 13 disposed blow the light guide plate 14, a diffuser 15 disposed above the light guide plate 14, and a prism 16 disposed above the diffuser 15.

According to the above mentioned embodiments, the periphery area of the prism 16 is formed as a flat surface by an integrity process or mold punching process, and thus light condensing, light leakage and bright lines of the prism may be reduced. Further, since ink is printed on the back surface of the periphery area, optical qualities of the prism may become superior. As such, the purpose of light condensing of the prism may be reduced, and thus thickness of the backlight module may be reduced and use efficiency of the backlight may be promoted.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims and their equivalents.

What is claimed is:

1. A prism applied to a backlight module, comprising:
a central area on which geometrical units being formed and arranged adjacent to each other on said prism; and
a periphery area, being a planar structure, located at two sides outside said central area and terminated at edges of said prism.

2. The prism according to claim 1, wherein said geometrical units is formed integrally.

3. The prism according to claim 1, wherein said planar structure is formed integrally through a mold or a mold punching method.

4. A prism applied to a backlight module, comprising:
a central area on which first geometrical units being formed and arranged adjacent to each other on said prism; and
a periphery area on which second geometrical units being formed and arranged adjacent to each other on said prism located at two sides outside said central area and terminated at edges of said prism, and having a shielding surface formed by an ink print method on a lower surface of said periphery area.

5. The prism according to claim 4, wherein the first geometrical units and the second geometrical units are integrated as a whole.

6. A prism applied to a backlight module, comprising:
a central area on which geometrical units being formed and arranged adjacent to each other on said prism; and
a periphery area, being a planar structure, located at two sides outside said central area and terminated at edges of said prism and having a shielding surface formed by an ink print method on a lower surface of said periphery area.

7. The prism according to claim 6, wherein said geometrical units are formed integrally.

8. The prism according to claim 6, wherein said planar structure is formed integrally through a mold or a mold punching method.

9. A backlight module, comprising:
a reflective mask having a chamber;
a lamp unit disposed on said chamber;
a light guide plate disposed on one side of said lamp unit;
a reflector disposed blow said light guide plate;
a diffuser disposed above said light guide plate; and
a prism disposed above said diffuser, wherein said prism includes a central area on which geometrical units being formed and arranged adjacent to each other on said prism; and
a periphery area, being a planar structure, located at two sides outside said display area and terminated at edges of said prism.

10. The backlight module according to claim 9, wherein said geometrical units are formed integrally.

11. The backlight module according to claim 9, wherein said planar structure is formed integrally through a mold or a mold punching method.

12. A backlight module, comprising:
a reflective mask having a chamber;
a lamp unit disposed on said chamber;
a light guide plate disposed on one side of said lamp unit;
a reflector disposed blow said light guide plate;
a diffuser disposed above said light guide plate; and
a prism disposed above said diffuser, wherein said prism includes a central area on which first geometrical units being formed and arranged adjacent to each other on said prism; and
a periphery area on which second geometrical units being formed and arranged adjacent to each other on said prism, located at two sides outside said central area and terminated at edges of said prism and having a shielding surface formed by an ink print method on a lower surface of said periphery area.

13. The backlight module according to claim 12, wherein said first geometrical units and second geometrical units are formed integrally.

14. A backlight module, comprising:
a reflective mask having a chamber;
a lamp unit disposed on said chamber;
a light guide plate disposed on one side of said lamp unit;
a reflector disposed blow said light guide plate;
a diffuser disposed above said light guide plate; and
a prism disposed above said diffuser, wherein said prism includes a central area on which geometrical units being formed and arranged adjacent to each other on said prism; and
a periphery area having a shielding surface formed by an ink print method on a lower surface of said periphery area.

15. The backlight module according to claim 14, wherein said geometrical units are formed integrally.

16. The backlight module according to claim 14, wherein said planar structure is formed integrally through a mold or a mold punching method.
